(19) United States
(12) Patent Application Publication
(10) Pub. No.: US 2022/0237585 A1
(43) Pub. Date: Jul. 28, 2022

(54) Personal Transaction Mobile Device Application with Validation and Tracking

(71) Applicants: Daren Presbitero, Ashburn, VA (US); Kainoa Isamu Presbitero, Ashburn, VA (US)

(72) Inventors: Daren Presbitero, Ashburn, VA (US); Kainoa Isamu Presbitero, Ashburn, VA (US)

(21) Appl. No.: 17/158,800

(22) Filed: Jan. 26, 2021

(51) Int. Cl. G06Q 20/32; G06Q 20/38; G06Q 20/40; G06Q 20/06

(52) U.S. Cl. CPC G06Q 20/3226; G06Q 20/06; G06Q 20/401; G06Q 20/389

(57) ABSTRACT

A personal transaction mobile device software application (app) with payment system is disclosed. The method allows friends to form mutual agreements pertaining to financial transactions for products and services using mobile devices. Once each friend agrees to a purchase goods and services, the app divides the cost into amounts each person pays. The app also tracks payments and broadcasts transactions to other users. For example—while shopping, a roommate learns that detergent can be purchased cheaply in bulk. Rather than calling roommates to discuss options, they enter the amount into the app. The app automatically splits the price equally and sends a message to the other roommates for approval. If the roommates agree, the app is used to make the payment and they all receive messages showing who has paid their share. An object of the invention is to streamline sharing payments for goods and services with friends.

### CROSS-REFERENCE TO RELATED APPLICATIONS

This application claims the benefit of U.S. Provisional Patent Application No. 38452065 filed on Jan. 30 2020.

### FIELD OF THE INVENTION

The present invention generally relates to mobile device applications. More specifically, it relates to a mobile device application that allows friends to split and monitor personal transactions amongst each other.

### BACKGROUND

Digital payments can be directly linked to the beginning of the internet, which can be traced back to ARPANET, developed by the United States during the Cold War and launched at the end of the 1960s. In the late 1980s, when Tim Berners-Lee came up with the concept of web pages and sites that could be linked together by hyperlinks digital payments became a more realistic proposition. The first online payments began in the 1990s. The Stanford Federal Credit Union was the first institution to offer online banking services to customers in 1994. However, early online payment systems were not very user friendly and required specialized knowledge of ‘data transfer protocols.’ Early players in digital payments were Millicent and Ecash, which offered services that used micropayment systems and electronic alternatives to cash, such as e-money, tokens or digital cash. The founding of e-commerce pioneer Amazon in 1994 provided further impetus to these early digital payment efforts. One of the earliest companies to specialize in online payment was PayPal, which started as an online money transfer service in 1999. Its popularity took off when it became popular with eBay users. PayPal consistently innovated, with features like payments that could be made using email addresses, the addition of new currencies, mobile payment apps, HTML payment buttons, and using a reverse Turing test (to determine if an interaction was human or machine) to reduce fraud. Today, companies such as Paypal offer a wide array of financial services and some have begun developing more person-centered payment options between individuals. U.S. Pat. No. 9,123,038B2 granted to Cozens et. al. disclosed methods for discovering and paying debts owed by groups of users; however it does not include contracts. United States Patent No. US20070255653A1 granted to Tumminaro et. al. disclosed mobile person-to-person payment systems and does not incorporate splitting payments. And United States Patent No. US20170236094A1 granted to Shah disclosed a blockchain-based crowd sourced initiatives tracking system but does not incorporate payment notifications from stakeholders.

### SUMMARY OF THE INVENTION

The device herein disclosed and described provides a solution to the shortcomings in the prior art through the disclosure of an app that allows friends to form mutual agreements pertaining to sharing financial transactions for products and services. Rather than engaging in lengthy arguments whereby friends are constantly texting or emailing about terms of an arrangement, the app automatically sends the proposal to all friends to view and provide input at once. For example, if a friend is interested in purchasing a catering service for a party that will be shared amongst friends, they post the service and the cost of said service on the app and it is instantly sent to the other friends who can see what their expected contributions will be and they can either agree or disagree to the arrangement.

Another object of the invention is to provide a means to allow users to validate the terms of a shared agreement in real time for all group members. In the above example, when a friend agrees to the catering arrangement they click on a button that sends a validation to all other friends alerting them that they intend to take responsibility for their shared amount.

Another object of this invention is to provide a means to divide or split up the costs stipulated in the agreement to each member based on the total number of members participating on the app. For example, if the friend above selects a catering service that costs $100, the app will notify the other three friends that their expected contributions will be $25 each.

Another object of the aforementioned invention is to allow a user to adjust to changes in an agreement and recalculate equal shares among remaining individuals who have agreed. From the example above, if one friend should decide to back out of the agreement, the app will automatically recalculate expected shares and all three members will be expected to agree to contribute $33.33 instead.

Another object of the aforementioned invention is to allow users to pay for an agreed service using a multitude of payment options directly within the app (such as PayPal, Venmo etc.).

Another object of the aforementioned invention is to allow users to tracks friends' payment status and automatically broadcast this information to its members so that everyone understands who has taken responsibility for the shared costs of an agreement.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the mobile device software application in operation.

FIG. 2 shows a representative view of the mobile device software application.

FIG. 3 shows an example of the mobile device software application operations.

FIG. 4 shows the inventive method of the mobile device software application operations.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

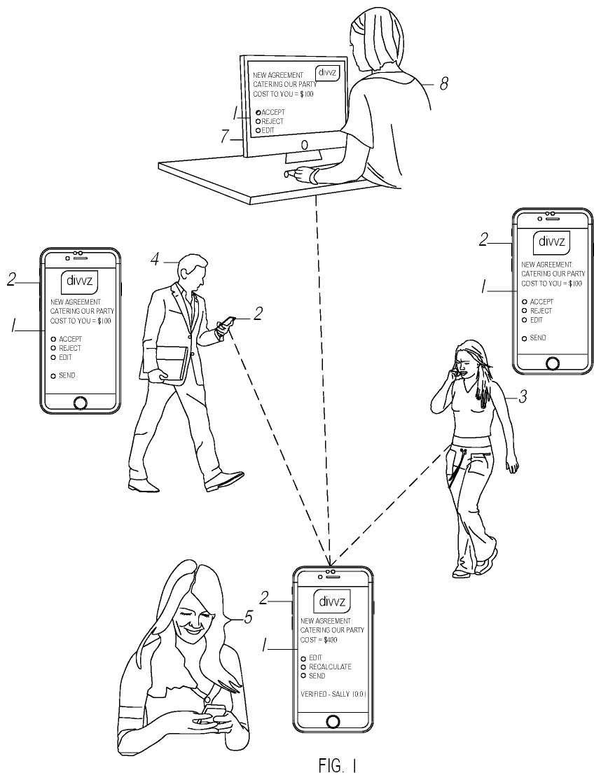

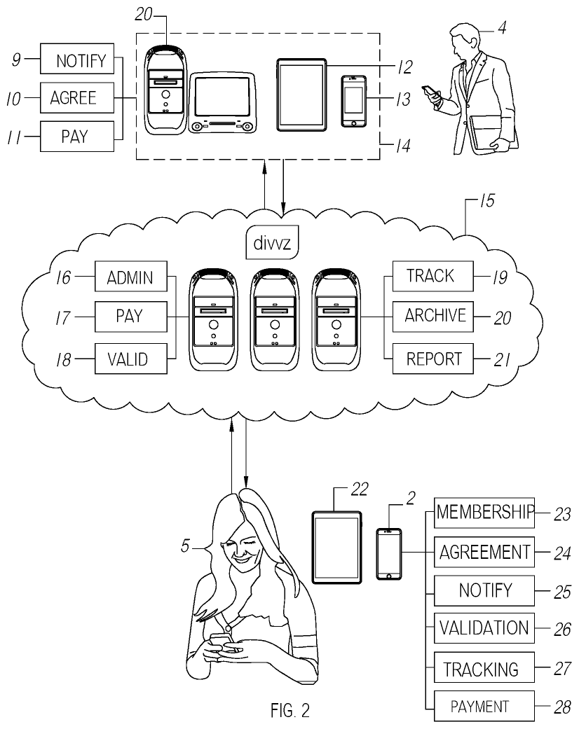

FIG. 1 shows an extremely simple overview of the mobile device software app (app) with a user 5 generating a proposal for goods and services with other parties 3, 4 and 8. FIG. 1 also showing the invention being comprised of app 1 in operation on computer devices such as but not limited to smart phones 2 and desktop computer 7. Said app 1 software being written from code that may include, but not be limited to: Java, C++™, Visual Basic™, Linux™, Basic™ and the like. App 1 also compatible with a plurality of operating systems such as, but not limited to: Windows™, Apple™, and Android™, and compatible with a multitude of hardware platforms such as, but not limited to: personal desktops, laptops, tablets, smartphones and the like. App 1 having a plurality of digital, web pages with content that allows users to interact with algorithms therein. FIG. 2 shows an example of the invention process with user 5 using a smartphone 2 and tablet 22 having functions such as but not limited to: membership attributes and registration (demographics, user id and password etc.); setting up proposals (descriptions, prices, member inclusion etc.); receiving and sending validations 26 regarding who and when an agreement was either accepted or rejected, or agreement edits and suggestions etc.; and tracking payment status from all participants 27 such as the amount and time a payment was made etc. The figure showing another user 4 receiving agreement notifications 9 that include but are not limited to agreement offers from other members; engaging in agreement actions 10 such as but not limited to accepting, rejecting or requesting an edit of agreement terms and making term suggestions etc.; and making payments 11 using existing conventional platforms such as paypal, venom and the like. All app functions for users being performed on computing devices 14 such as desktop computers 20, tablets 12 and smartphone 13.

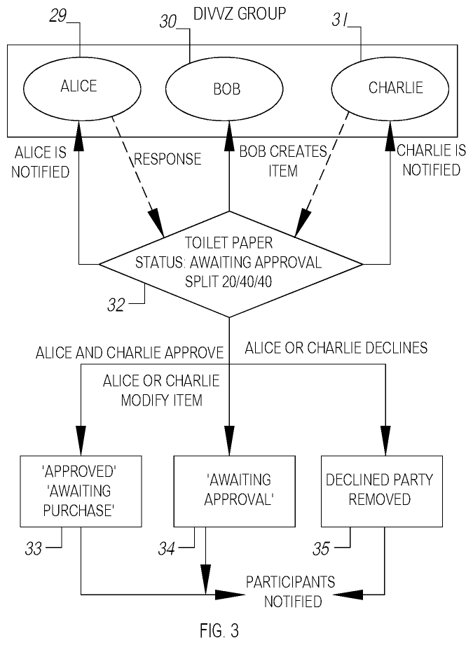

The figure also showing all users being connected by the app's cloud network 15 having algorithms that include but are not limited to: administrative operations 16 (membership demographics, subscriptions etc.); payment links 17 to existing platforms; validation functions 18 with notifications across members; tracking members 19 across members; archives of contracts and transactions 20 (encrypted and available to all members); and reporting 21 (summary reports of proposals, transactions, agreements and payments etc.) available to all members therein. FIG. 3 shows an example of the invention process wherein member Bob 30 creates an agreement relating to stocks of toilet paper for the other members he lives with having a shared responsibility payment of 20%, 40% and 40% split. Members Alice 29 and Charlie 31 are notified by the app and Bob 30 is notified of pending status 32 of said agreement with other members. If Alice 29 and Charlie 31 approve of said contract the item (or contract) status is changed to approved and the app requests payment from the members 33 and all members are notified. If Alice 29 or Charlie 31 reject said contract the item (or contract) status is changed to declined and the app only requests payment from Alice 29 and Charlie 31 is removed from contract 35 and all members are notified and amounts are recalculated based on the pending status 32. If Alice 29 and Charlie 31 modify the contract, the app resets to a ‘waiting approval’ state and all members are notified.

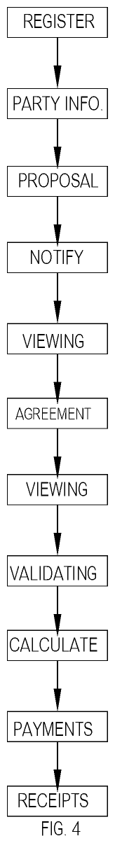

FIG. 4 shows the inventive method of the mobile device software application operations including but not limited to: the user registering a user name and password and inputting their information, demographics and subscription information; the user entering other party information and demographics and paying for said subscription by means of an online payment method; the user entering goods and services information into a proposal; the user selecting parties and sending the proposal notification to parties; the parties viewing proposal after receiving the notification; the parties agreeing or disagreeing to the proposal and sending notification of agreeing or disagreeing to the user as well as all parties; the user and all parties viewing agreeing or disagreeing notifications from parties; the user validating the agreement and sending the agreement to the parties; the user entering the amount of the goods and services, calculating the amount due by each party and notifying the parties of the amounts due; the amounts due and making payment transactions; and the parties viewing payment receipt for the purchase. All of the aforementioned steps are saved to the computing devices and cloud networks at each stage.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A method of sharing costs for goods and services that includes the following inventive steps:
a) providing a computer device having a memory and an input means for inputting information, a display, and loading said computer device with a mobile software application for operating said method;
b) providing a secure cloud network connecting to said computer device;
c) providing a mobile software application accessible to said computer device via said secure cloud network whereby said software application facilitates displaying images on said computer device display including:
i) a main page with links to subsequent pages, clicking on said links facilitating access to said subsequent pages;
ii) said subsequent pages including:
A) a first page in which the user registering a user name and password and inputting their information, demographics and subscription information;
B) a second page in which the user entering other party information and demographics;
C) a third page in which the user entering goods and services information into a proposal;
D) a fourth page in which the user selecting parties and sending the proposal notification to parties;
E) a fifth page in which the parties viewing proposal after receiving the notification;
F) a sixth page in which the parties agreeing or disagreeing to the proposal and sending notification of agreeing or disagreeing to the user;
G) a seventh page in which the user viewing agreeing or disagreeing notifications from parties;
H) a eight page in which the user validating the agreement and sending the agreement to the parties;
I) a ninth page in which the user entering the amount of the goods and services, calculating the amount due by each party and notifying the parties of the amounts due;
J) a tenth page in which the parties receive the amounts due and making payment transactions; and
H) an eleventh page in which the parties viewing payment receipt for the purchase.

2. The method of sharing costs for goods and services of claim 1 wherein the first page in which the user registering a user name and password and inputting their information, demographics and subscription information includes the step of paying for said subscription by means of an online payment method and inputting said profiles into said computer device memory and said secure cloud network memory.

3. The method of sharing costs for goods and services of claim 1 wherein the second page in which the user entering other party information and demographics includes the step of inputting said other party information and demographics into said computer device memory and said secure cloud network memory.

4. The method of sharing costs for goods and services of claim 1 wherein the third page in which the user entering goods and services information into a proposal includes the step of saving said proposal into said computer device memory and said secure cloud network memory.

5. The method of sharing costs for goods and services of claim 1 wherein the fourth page in which the user selecting parties and sending the proposal notification to parties includes the step of saving selecting parties and sending the proposal notification to parties into said computer device memory and said secure cloud network memory.

6. The method of sharing costs for goods and services of claim 1 wherein the sixth page in which the parties agreeing or disagreeing to the proposal and sending notification of agreeing or disagreeing to the user includes the step of sending said parties' agreements and disagreement notifications to all parties and saving agreements and disagreement notifications into said computer device memory and said secure cloud network memory.

7. The method of sharing costs for goods and services of claim 1 wherein the seventh page in which the user entering the amount of the goods and services, calculating the amount due by each party and notifying the parties of the amounts due includes the step of saving amounts due into said computer device memory and said secure cloud network memory.

8. The method of sharing costs for goods and services of claim 1 wherein the eight page in which the parties receive the amounts due and making payment transactions includes the step of sending transactions to all parties and saving the transactions into said computer device memory and said secure cloud network memory.

9. The method of sharing costs for goods and services of claim 1 wherein the ninth page in which the parties viewing payment receipt for the purchase includes the step of saving the payment receipt into said computer device memory and said secure cloud network memory.
